(19) United States
(12) Patent Application Publication
(10) Pub. No.: US 2005/0166493 A1
(43) Pub. Date: Aug. 4, 2005

(54) Alarm plug for a vinyl window

(76) Inventor: C. Brian Martin, Kingwood, TX (US)

Correspondence Address: Clarence E. Eriksen;JACKSON WALKER L.L.P., Suite 2100, 112 E. Pecan Street, San Antonio, TX, 78205, US

(21) Appl. No.: 10/753,785

(22) Filed: Jan. 8, 2004

(51) Int. Cl. E06B 1/04

(52) U.S. Cl. 52/204.1

(57) ABSTRACT

An alarm plug for use in a vinyl window which allows for the installation of security instrumentation, which prevents any collected water in the main frame of the window from entering the structure below the main frame.

### BACKGROUND OF THE INVENTION

1. Field of the Invention

The present invention relates to apparatus for use in a vinyl window which permits communication between the top of the main frame of the window and the structure below the main frame without allowing water in the main frame from entering the structure below the main frame.

2. Description of Prior Art

Vinyl windows have enjoyed popularity over traditional wood and metal windows. Vinyl windows not only enhance the beauty of a home or other structure in which they are installed, but also vinyl windows are relatively maintenance free, meet or exceed standards for heat gain or heat loss, and are more energy efficient than wood windows at about half the cost of wood windows. The natural insulating qualities of a well-engineered vinyl window reduce heat and cold transfer and provide energy efficiency which is substantially better than an aluminum window. A high quality vinyl window does not pit, rust, fade, peel, chip, corrode, lose its color, rot, crack, or ever need painting. Additionally, the color of the vinyl window is fully integrated through out the vinyl and is prevented from fading by ultra-violet protectants that are chemically bound into the material. Usually, only soap and water are required to clean the window and restore it to its original appearance.

Despite their advantages, there is a potential problem when using vinyl windows with a pocket still design when the homeowner desires to install a security system. Such a system typically comprises a magnet which is installed in the bottom side of the sash of the window and a corresponding stinger which is installed in the main frame. When the window is closed, contact exists between the stinger and the magnet.

Installation of the stinger is effected by drilling a hole through the main frame and the supporting stud for the window. The stinger includes two wires which pass through the hole in the main frame of the vinyl window and through the hole in the stud holding the window, and which are connected in an appropriate manner to the security system. Once such an arrangement is installed in a window, a lifting of the window when the security system is activated will break the contact between the magnet and the stinger, and the alarm of the security system will be activated.

When a vinyl window with a pocket still design is subjected to rain, the window will tend to collect water in the bottom portion of the main frame. Normally, this collected water drains out of the bottom portion of the main frame through weep holes that are formed in the vinyl window during manufacture. However, when a security device as described above is installed in a vinyl window, some of this water will also pass through the hole that has been drilled in the window and the underlying stud. The water which passes through this hole may cause substantially damage to the structure of the building underneath the vinyl window.

### SUMMARY OF THE INVENTION

In accordance with the present invention, an alarm plug is provided for use in a vinyl window to permit the installation of security instrumentation in the vinyl window, while preventing water in the main frame from entering the structure below the main frame.

In accordance with the present invention, an alarm plug is fabricated having a bottom end and a top end and bore therethrough. The liner is fabricated as a unitary structure for installation in a vinyl window which has a main frame with a base having a predetermined thickness.

The alarm plug comprises a threaded portion at the bottom end for engagement with a corresponding threaded portion of the base of the main frame. The threaded portion of the alarm plug has a length that is substantially equal to the thickness of the base of the main frame, which results in the bottom end of the liner being flush with the bottom of the main frame when the liner is installed.

An alarm plug in accordance with the present invention also includes a flange portion which is proximate to and above the threaded portion. The flange portion is adapted to receive a sealing material which forms a seal between the flange and the top of the base of the main frame when alarm plug is in threaded engagement with the main frame. Preferably, the sealing material is an O-ring, and the flange is preferably undercut to receive this O-ring.

An alarm plug in accordance with the present invention also includes a shaft portion between the top of the flange and the top end of the alarm plug. The shaft portion has a length such that the top end of the alarm plug is flush with the top of the main frame when the alarm plug is installed. Preferably, the shaft portion of the liner has an external configuration to facilitate the installation of the alarm plug in the vinyl window. Such an external configuration may, for example, be a hexagonal shape.

### BRIEF DESCRIPTION OF THE DRAWINGS

FIG. 1 is a front perspective view of a vinyl window which is installed in a structure.

FIG. 2 is a section perspective view of the main frame of a vinyl window in accordance with the present invention.

FIG. 3 is a partial sectional view of a vinyl window in accordance with the present invention which is installed in a structure.

FIG. 4 is a cross sectional view of the main frame of a vinyl window in which an alarm plug in accordance with the present invention is installed.

FIG. 5 is a top view of the alarm plug 18 of FIG. 4.

### DESCRIPTION OF SPECIFIC EMBODIMENTS

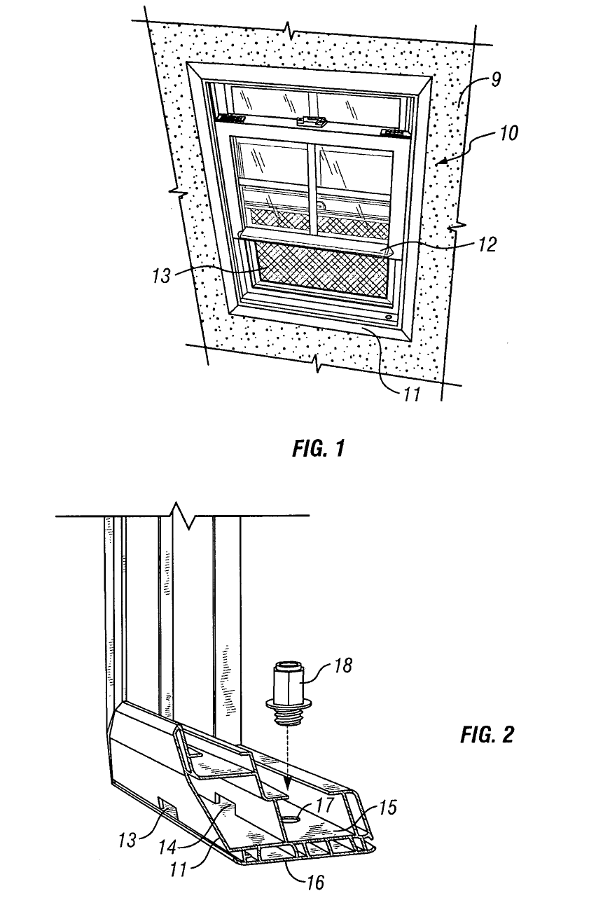

With reference first to FIG. 1, a vinyl window 10 is shown installed in a structure 9, which may, for example, be a home. Vinyl window 10 comprises a main frame 11 around the periphery of the window 10 and a sash 12 which is raised and lowered to open the window. The window 10 may also comprise a screen element 13.

With reference now to FIG. 2, there is illustrated a partial cross-section perspective view of the main frame 11 of the vinyl window 10. The main frame 11 is preferably 200 nail flange which is available from Vinyl Building Products Inc. at www.vinyline.com. The main frame 11 comprises a base portion with a top 15 and a bottom 16 and a web-like structure 17 interposed between top 15 and bottom 16 for rigidity.

It is well-known that a vinyl windows with a pocket still design will collect water in the bottom portion of the main frame 11 on the top 15 of the base of the main frame. Accordingly, weep holes 13 and 14 are formed in the base member 11 during manufacture of the window, and these weep holes permit any water that collects in the main frame to run off to the outside of the structure in which the window is installed.

Reference to FIG. 4, if a vinyl window is installed with a security alarm, a hole is normally drilled in the sash 12 of the window to receive a magnet. A corresponding hole is also drilled through the main frame 11 and through the supporting stud 19 in which the window is installed. This hole is drilled through the snap-in sill filler 23, through the base of the main frame, and through the supporting stud for the window. A stinger is then installed in the main frame, and the stinger includes a pair of wires which pass through the hole in the main frame of the vinyl window and through the hole in the stud and which are connected to an appropriate security system (not shown). Prior to the present invention, water which collects in the main frame was able to pass through the hole that was drilled in the main frame and into the supporting stud 19. This water could very likely cause damage to the supporting structure under the window.

In accordance with the present invention, a alarm plug is provided for use in a vinyl window is provided. The liner permits the installation of security instrumentation in the vinyl window while preventing water in the main frame from entering the structure below the main frame.

With reference now to FIGS. 2 and 4, an embodiment of alarm plug 18 in accordance with the present invention is illustrated. Alarm plug 18 has a top end 18g and a bottom end 18f and a bore 18h through the alarm plug. Alarm plug 18 comprises a threaded portion 18a at the bottom end 18f of the alarm plug for engagement with a corresponding threaded portion 17. The threaded portion 18a of the alarm plug 18 has a length which is substantially equal to the thickness of the base member defined by top member 15 and bottom member 16. As illustrated in FIG. 4, the bottom end of the alarm plug 18 is flush with the bottom member 16 of main frame 11 when the alarm plug 18 is installed in the main frame.

Still referring to FIG. 4, an alarm plug 18 in accordance with the present invention also includes a flange portion 18b which is proximate to and above the threaded portion 18a of the alarm plug. The flange portion 18b is adapted to receive a sealing material 18c. When the alarm plug 18 is installed in a vinyl window as illustrated in FIG. 4, the sealing material 18c forms a seal between the flange and the top member of 15 of the base of the main frame 11. In a preferred embodiment, the sealing material 18c is an O-ring, and the flange 18b is preferably undercut as shown in FIG. 4 to receive this O-ring.

An alarm plug in accordance with the present invention also includes a shaft portion 18d which is formed between the top of the flange 18b and the top end 18g of the alarm plug. The shaft portion 18d has a length such that the top end 18g of the alarm plug is flush with the snap-in filter 23 of the main frame 11, when the alarm plug and snap-in filler 23 are installed.

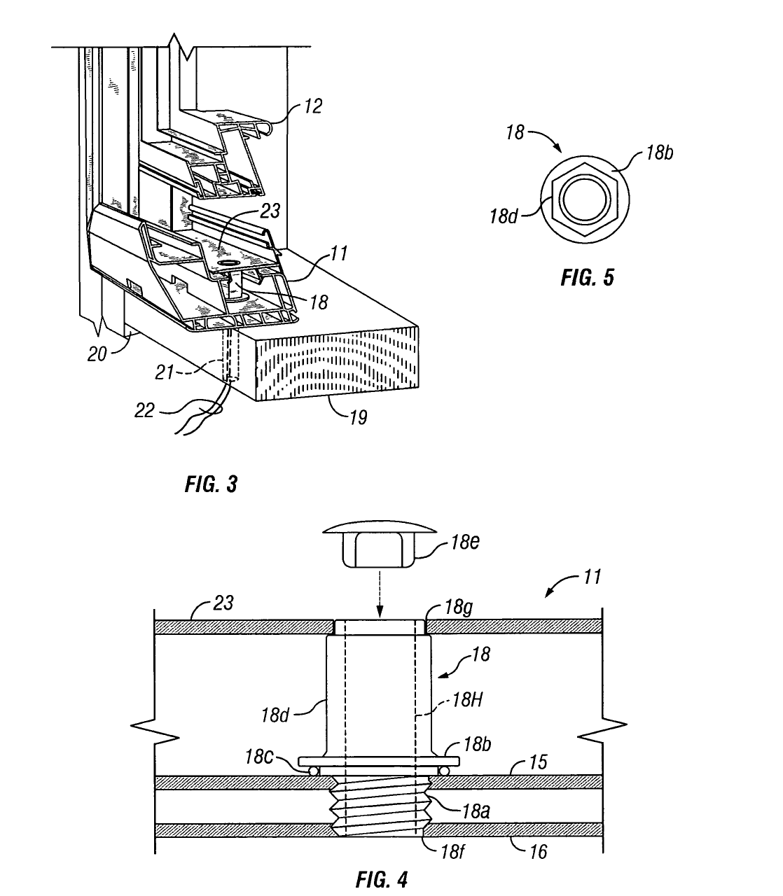

With reference to FIGS. 2 and 3, alarm plug 18 is installed in the base of the main frame 11 during manufacture of the window. Snap-in filler 23 is then installed in the main frame 11. A cap 18c be placed in the bore 18h of alarm plug 18 during manufacture of the window and may remain in place until such time as it is desired to install security instrumentation. At that time the cap 18e may be removed and a drill bit to drill the hole in the supporting stud may be inserted through the bore 18h in alarm plug 18 to drill a hole through the stud.

Alarm plug 18 may be fabricated from a variety of suitable materials, but is preferably polycarbonate injection molded plastic. The shaft portion 18d of the alarm plug 18 has an external configuration to facilitate the installation of the alarm plug, and that external configuration preferably has a hexagonal shape.

1. An alarm plug having a bottom end and a top end and a bore therethrough, which alarm plug is fabricated as a unitary structure for installation in a vinyl window having a main frame with a base of a predetermined thickness, the alarm plug comprising:
(a) a threaded portion at the bottom end for engagement with the base of the main frame, the threaded portion having a length that is substantially equal to the thickness of the base of the main frame;
(b) a flange proximate the threaded portion which is adapted to receive a sealing material which forms a seal between the flange and the top of the base of the main frame when the alarm plug is in threaded engagement with the main frame; and
(c) a shaft portion between the top of the flange and the top end of the alarm plug, the shaft portion having a length so that when the alarm plug is installed, the top end of the alarm plug is flush with the top of the main frame.

2. The alarm plug of claim 1, wherein the sealing material is an O-ring.

3. The alarm plug of claim 2, wherein the flange is undercut to receive the O-ring.

4. The alarm plug of claim 1, further comprising a cap to close of the bore of the alarm plug at the top end of the liner.
